(19) United States
(12) Patent Application Publication
(10) Pub. No.: US 2024/0288160 A1
(43) Pub. Date: Aug. 29, 2024

(54) METHOD FOR BURNING A LIQUID OR GASEOUS FUEL IN A BOILER, BOILER FOR CARRYING OUT THE METHOD AND THERMAL BATH HAVING A BOILER

(71) Applicant: SWISS E-FUTURTEC AG, Mastrils (CH)

(72) Inventors: Jörg Füllemann, Mastrils (CH); Roman Koch, Chur (CH)

(21) Appl. No.: 18/686,852

(22) PCT Filed: Aug. 25, 2022
(86) PCT No.: PCT/CH2022/050023

§ 371 Date: Feb. 26, 2024

(30) Foreign Application Priority Data
Aug. 26, 2021 (CH) 070205/2021

(51) Int. Cl. F23D 17/00; F23D 11/02; F23D 14/70; F23N 3/00

(52) U.S. Cl. CPC F23D 17/002; F23D 11/02; F23D 14/70; F23N 3/002; F23D 2204/10; F23N 2225/06

(57) ABSTRACT

A method and a boiler for burning a liquid or gaseous fuel. The boiler comprises a boiler housing with a cylindrical heat exchanger arranged therein and has slot-like pass-through openings for the combustion gases and has a flame tube. A flame-deflecting part for deflecting the combustion gases at a right angle is provided at an axial distance from the flame tube. The flame tube contains a baffle plate with a faceplate through which combustion air is fed into the flame tube. A blower ensures the supply of combustion air into the combustion chamber. Blower pressure is so that a differential pressure zone with a differential pressure of at least 0.25 mbar is generated between the flame tube and the heat exchanger, downstream of the faceplate at full load of the burner in relation to the pressure in the combustion chamber in the region of the recirculation slots.

### CROSS-REFERENCE TO RELATED APPLICATIONS

This application is a national phase entry under 37 U.S.C § 371 of PCT/CH2022/050023 filed Aug. 25, 2022, which claims priority to Swiss Patent Application No. 070205/2021 filed Aug. 26, 2021, the entirety of each of which is incorporated by this reference.

### BACKGROUND

### Field of the Invention

The present invention relates to a method and apparatus for burning a liquid or gaseous fuel in a boiler, in particular in a condensing boiler, using a blue flame burner, a boiler, and a thermal bath with a boiler.

### State of the Art

A “yellow burner” is a burner that burns with a visible “yellow flame.” It describes the classic design of an oil pressure atomizing burner, in which a pump feeds the oil fuel through a nozzle and finely atomizes it. After the necessary preheating, a fine spray mist is produced. This fine spray mist is ignited by an electric arc and the entire oil mist from the incoming fuel oil vaporizes in the flame until the fuel supply is interrupted. Due to the high temperatures and the lack of oxygen in the combustion zone, nitrogen oxide emissions increase in this region. Soot is also produced, the particles of which cause the bright yellow flame color. The consequences thereof are high exhaust gas values (CO, NOx), soot, and coking of the burner.

A characteristic feature of a yellow burner is the baffle plate, which is designed to mix the oil mist with the necessary combustion air. It generally divides the air flow into three partial flows, which enter the firing space via different routes. Whereas the primary air flows through an opening with the oil mist, the secondary air enters the firing space via a gap between the burner tube and baffle plate. Air also flows into the firing space via tangential slots. These slots give the flame a certain swirl so that combustion air and oil mist mix better. An air cushion moreover arises from the third air flow that protects the baffle plate from excessive thermal stress. In the case of small burners, starting from approximately 22 kW, the diameter of these baffle plates is at least 50 mm to 65 mm. The combustion air pressure in front of this baffle plate is maximum approximately 5 mbar. Until the 1990s, the combustion air pressure was generated by the burner motor with blower wheel at up to 2,800 rpm (standard motor).

Older yellow burners, in particular, require more air for combustion. Experts refer to this as higher excess air. This does, however, also provide for higher exhaust gas volumes and increasing exhaust gas losses. Yellow burners therefore work less efficiently and heating costs are higher. The soot count of yellow burners is also higher than that of blue flame burners, which means that dust emissions are higher. Modern appliances, which were developed at the beginning of the 1990s, are cleaner and more economical thanks to optimized exhaust gas recirculation.

The way a blue flame burner works is very similar to that of a yellow flame burner when starting the combustion process. The differences in the design, however, show their effect after a few seconds: a negative pressure generated behind the nozzle sucks hot exhaust gases back out of the flame tube. These vaporize the oil mist and enable a much better mixture with the combustion air. The flame then burns like a gas burner and glows in the typical blue color.

Recirculation openings at the beginning of the flame tube also draw cooled combustion gases out of the combustion chamber. These reduce the combustion temperature and therefore also the nitrogen oxide emissions of the blue flame burners. They manage with less excess air and achieve lower exhaust gas losses than yellow burners. The appliances make better use of the fuel and thus reduce heating costs. A further advantage lies in higher CO₂ content of the exhaust gases. This is because the higher CO₂ content raises the dew point and thus promotes the condensing effect.

The combustion chamber pressure in the boiler at its maximum output is usually around minus 0.05 mbar. The main reason for the low negative pressure, even at rated output, is that no exhaust gases can enter the boiler room from the combustion chamber.

This test condition for TUV approval has led burner manufacturers to configure the blower pressure on the burner between 2 mbar and maximum 5 mbar for decades, especially in the low output range of approximately 25 kW/h.

Accordingly, the developments and improvements have concentrated on oil burners with low output (17.5 kW to 25 kW) in coordination with the blower pressure of maximum 4 mbar. For this reason, practically all patents relating to the burner head and the baffle plate have been configured for a low blower pressure. The controllability of such a burner is 25% to maximum 30%.

The diameter of a baffle plate for the classic atomizing burner is at least approximately 60 mm or more for practically all manufacturers with a low output of approximately 25 kW. The inside diameter of the opening in the baffle plate for the atomizer nozzle is at least 18 mm. Recirculation flows for exhaust gases can only be influenced to a limited extent with the weak blower pressures used and quickly lead to instability.

Low-sulfur fuels and liquid biofuels pose a major risk of so-called “metal dusting”, especially if these fuels are mixed and the mixing ratio is above 10%. “Metal dusting” is particularly favored when fuel droplets hit hot metal parts such as flame tubes etc. and vaporize in the presence of oxygen and combustion gases. Long post-ignition times also promote the formation of “metal dusting” because the high ignition voltage in a flame plasma leads to pulsating direct current and carbon towers (nanotubes) form on the metal surface. If small craters form on the metal surface during this process, “metal dusting” can no longer be stopped.

European patent EP 0 970 327 discloses a boiler equipped with a blue flame burner with a housing enclosing a boiler room and a jacket-shaped heat exchanger which divides the boiler room into a boiler chamber and an exhaust gas chamber and has pass-throughs for hot combustion gases distributed over the casing surface. A burner head is arranged in the boiler chamber, which burner head comprises a flame tube with an axial flame opening. A flame-deflecting part is provided at a distance from the flame opening and is designed to deflect the flame into the space between the flame tube and the heat exchanger. The pass-throughs for hot combustion gases are moreover distributed over the entire length of the boiler chamber. The disclosed boiler with burner has the advantage that it can be configured to be very short, because the flame is deflected at a 180 degree angle and is thus provided sufficient time for complete combustion.

WO2004038291A1 discloses a burner head which works without a flame tube and yet achieves good flame stability. The burner head has a faceplate with at least two, preferably four, openings with uniformly inclined guide blades which serve to feed supply air to a combustion chamber. There are baffle vanes between the openings to form peripheral negative pressure zones between the supply air jets. The supply air jets are directed by the guide blades into a position that is inclined with respect to an axis. In this way, the supply air jets diverge, thereby creating a central negative pressure zone around the aforementioned axis between the supply air jets. A rotation of the supply air is brought about by the central negative pressure and the inclination of the supply air jets. During operation of the burner, hot gases are drawn in from the outside into the peripheral negative pressure zones and against the flow direction of the supply air into the central negative pressure zone between the supply air jets. These flow conditions create ideal conditions for the combustion of gaseous, liquid and/or particulate fuel in a calm, cool and low-emission flame. This type of combustion should be practically independent of the combustion chamber size and combustion chamber shape.

EP-A-0867658A1 shows an oil burner for the combustion of liquid fuel with exhaust gas recirculation, which burns independently of the furnace chamber with low exhaust gas emissions and calm combustion, in which air is blown through a central air opening into a flame tube and exhaust gas is recirculated into the flame tube through recirculation openings by the suction effect of the air in such a way that it envelops the central air flow. The fuel is sprayed in the direction of flow in front of the flame root into the exhaust gas surrounding the air flow, where it vaporizes. The vaporized fuel is only then swirled with the air together with the exhaust gas.

A burner operating according to this method has a centrally arranged fuel nozzle with a conical casing characteristic and a baffle plate with an air opening. Adjacent to the baffle plate in the direction of flow, there is a flame tube which has recirculation slots of approximately 1 mm in width directly by the baffle plate and round recirculation openings with a diameter of approximately 6 mm near the baffle plate for the intake of exhaust gas into a negative pressure region behind the baffle plate in the direction of flow. The spray opening of the fuel nozzle lies approximately in the plane of the baffle plate generating the negative pressure. The baffle plate has only one opening, which forms an air inlet arranged concentrically in a ring around the fuel nozzle. Guide plates, which are arranged at an angle of between 60 and 88 degrees, cause a rotation of the air flowing into the flame tube. When the burner is in operation, exhaust gas from the surrounding combustion chamber is drawn in through the recirculation slots on the one hand and through eighteen round recirculation openings at a distance from the baffle plate on the other. The exhaust gas drawn in through the recirculation slots prevents soot deposits on the baffle plate. The mixing of fuel and air takes place in the region of the ignition electrode tips, which is to say, at a distance of around ⅖ of the length of the flame tube, which is 160 mm long in the example shown. The flame tube has a constriction at the end, which impedes the gas from flowing out of the casing region and thus promotes the turbulence of combustion air and fuel. A very good cold-start behavior is ostensibly achieved by these features and, according to the patent description, these features produce a hollow and cool flame.

The German utility model DE 90 12 283.6 U describes a burner for liquid or gaseous fuels with a flame tube which converges conically in its flame-side end section, an atomizer nozzle with hollow cone characteristics arranged concentrically in the flame tube at the end of a nozzle tube and a circular baffle plate which is offset inwards in relation to the mouth edge of the flame tube and which has a central through bore and several radial swirl slots with inclined air guiding surfaces. The baffle plate is provided on its circumference with an annular wall on the flame side, which wall is centered by radial centering webs of the flame tube and forms an open annular gap with the end section of the flame tube. It is significant that the air guiding surfaces run at an angle of approximately 30° to the radial plane of the baffle plate and are arranged on the atomizer nozzle side. The distance between the atomizer nozzle and the baffle plate is a maximum of 3 mm. When the burner is in operation, there is a pressure in the flame tube of approximately 8 to 10 mbar. The proposed air routing achieves an external recirculation in a recirculation zone from a yellow flame zone into the flame root.

The German patent DE 40 08 692 C2 discloses a mixing device for oil blower burners, consisting of a mixing tube as a pass-through for the combustion air, which tapers conically at its front end to an outlet diameter. A baffle plate is arranged in the mixing tube in the region of the conical taper, which baffle plate is attached to a nozzle assembly by means of a holder. The nozzle assembly and baffle plate are axially displaceable in the mixing tube. The baffle plate consists of a circular disk with a central inner hole for introducing the fuel and a first part of the combustion air into a combustion space, with radial inclined slots for tangentially introducing a second part of the combustion air into the combustion space and with a ring on its outer circumference, between which ring and the inner wall of the mixing tube a third part of the combustion air can be introduced into the combustion space. The mixing tube is bent at its tapered front end, radially inwards to such an extent that the outlet diameter is smaller than the diameter of the baffle plate. The height of the ring of the baffle plate facing the combustion space is, moreover, at least as tall as the diameter of the inner hole of the baffle plate.

According to one embodiment, an attachment tube is arranged in front of and coaxial to the mixing tube. It is fastened to the mixing tube by means of brackets in such a way that it overlaps the tapered front end. In this manner, an annular gap between the mixing tube and the attachment tube is created, through which tertiary recirculation takes place by guiding cooler combustion gases into the edge region of the flame, which is further cooled as a result. In this embodiment, the oil should burn almost stoichiometrically in an absolute blue flame.

The major disadvantage of all these burner systems is the need for adjustment options on the burner head. Depending on the boiler manufacturer, the exhaust gas pipe to the chimney, the chimney diameter, and the length of the chimney, the burner head must be adjusted with great skill by axial adjustment of the nozzle rod to the baffle plate, as well as of the radial opening on the baffle plate to the burner tube, such that the carbon monoxide measurements and in particular the soot are maintained in accordance with the standard.

### Task

The task of this invention is to propose a method for burning a liquid or gaseous fuel in a boiler which permits soot-free and low-emission combustion of a fuel, in particular mineral or vegetable oil, in the smallest possible space, which is to say, in a miniaturized boiler. One aim is to propose a boiler that can be configured even shorter than previously known boilers and is as simple as possible in construction. No complex adjustment work should likewise be necessary to optimally adjust the burner. A further aim is to propose a burner, the output of which can be regulated over a very wide range, which is to say, either in stages or advantageously continuously. Another aim is to propose a miniaturized boiler that can be produced at low cost and is particularly suitable for the spontaneous production of hot water. Another aim is to propose a burner for a boiler that burns with a “blue flame” after a very short time, which is to say, in particular within a few seconds. Another aim is to propose a burner that is suitable for burning renewable fuels (vegetable oils, etc.), which is to say, that no problems such as “metal dusting” occur. Another aim is that the burner can be operated without an oil preheater.

Another aim is to create a burner with a very short flame, which moreover also requires a very short flame tube and keeps the flame very stable on the flame tube without it needing to be flanged at the exit of the flame from the flame tube. Another aim is that the flow path of the oxidizing flame can be drastically shortened by rotation inside and outside the flame tube, such that the oxidation of the hot gases is already largely complete when the flame hits the deflecting part, before the hot combustion gases fall below the required emission values after a 90° deflection when they hit the helically wound heat exchanger tube with pass-through openings. Another aim is to configure the combustion air flow as it passes through the faceplate in such a way that, on the one hand, there is a high degree of rotation of the supplied combustion air with the mixing zone of hot gases and the vaporized fuel, and, on the other hand, a blue flame is generated which burns out in the flame tube and outside the flame tube with high rotation.

### Definitions

The oxidizing (“burning”) mixture of air and fuel is referred to as “hot gases.”

The “flame” is the visible part of the “hot gases.” Flame also refers to the invisible part of the flame until the oxidation in the combustion has fallen below the required values.

The term “combustion gases” refers to the gases escaping through the pass-through openings of the heat exchanger and from the combustion space.

The term “condensing boiler” refers to a boiler in which the enthalpy of vaporization of water is recovered.

A “blue flame burner” is a burner that burns with a visible “blue flame.”

The “combustion chamber” refers to the space bounded by the cylindrical heat exchanger, the flame-deflecting part, the burner housing base and the baffle plate.

The “combustion space” refers to the space within the combustion chamber where, for the most part, combustion takes place.

“Combustion chamber load” refers to the load of a burner per m³ of combustion chamber of a boiler at which the required exhaust gas values or alternatively the strictest standards can still be achieved. Conventional boilers only achieve the strictest exhaust gas standards up to a combustion chamber load of approximately 1.6 MW per m³ of combustion chamber content. The combustion chamber load results from the energy content of the fuel supplied per time unit multiplied by the volume contained per m³ of combustion chamber.

“Metal dusting” is an extremely destructive type of corrosion that occurs when vulnerable materials are exposed to a carbon-rich atmosphere. The corrosion manifests itself in the decomposition of solid metals into metal powder.

“Negative pressure”: The pressures specified in the description refer to the differential pressure compared to the ambient pressure, wherein the environment can also be the rest of the combustion chamber. A blower pressure of 30 mbar corresponds to 1030 mbar in absolute values at normal pressure.

The pressure specifications given in the description are relative to the ambient pressure of 1000 mbar, which is to say, 1000 mbar is equal to zero.

### SUMMARY OF THE INVENTION

The invention relates to a method and apparatus in which a blower pressure is adjusted such that downstream of the faceplate, at full load of the burner, a differential pressure zone is generated in the flame tube with a differential pressure of at least 0.25 mbar, advantageously at least 0.30 more advantageously or more advantageously at least 0.35 mbar compared to the pressure in the combustion chamber between the flame tube and the heat exchanger. The combustion chamber pressure is measured in the region of the first half of the flame tube, which is to say, between the recirculation slots and the center of the flame tube, at approximately the same height where the maximum differential pressure is measured in the flame tube. The method according to the invention has the advantage that the flame burns blue within fractions of a second and achieves the required exhaust gas values immediately after starting, without the fuel needing to be preheated. The flame is moreover immediately stable, and the output of the burner can be regulated over a very wide output range. A “stable flame” means that the flame does not flicker and the emissions relating to the carbon monoxide value in the exhaust gas are stable.

Advantageously, the combustion air is directed into the flame tube in such a way that, when the burner is under full load, the differential pressure zone, at a distance from the baffle plate, in particular at a distance between approximately 10 and 30 mm, advantageously approximately 10 mm after the faceplate, describes a maximum. This produces a particularly stable flame.

A differential pressure of between 0.01 and approximately 0.5 mbar is advantageously generated in the differential pressure zone to set the desired burner output. This considerably extends the dwell time of the hot gases in the flame tube, so that the combustion process is practically complete when the rotating hot gases hit the flame-deflecting part. This means that, in contrast to the teaching of EP-A-0 970 327 quoted at the beginning, a 180 degree deflection of the hot gases is no longer necessary for complete combustion, but rather serves to recirculate and support the vaporization of the supplied fuel.

Advantageously, the fuel-air mixture is fed into the flame tube at an angle such that a short, bushy flame shape is produced, such that at least 90%, advantageously at least 95% and more advantageously more advantageously at least 99.95% burnout occurs by the time the combustion gases are deflected at the deflecting part.

Advantageously, the fuel is vaporized approximately 5 mm to approximately 30 mm after exiting the nozzle in a hot, low-oxygen vaporization and mixing zone. This has the advantage that the fuel-air-gas mixture can be vaporized practically instantaneously after leaving the nozzle opening.

Advantageously, low-oxygen combustion gases are moreover recirculated from the combustion chamber surrounding the flame tube into the vaporization and mixing zone, which is located approximately 5 mm to approximately 30 mm after the fuel exits the nozzle. This has the advantage that sufficient heat energy is available immediately after starting the burner to vaporize the fuel.

Expediently, immediately after ignition of the flame, low-oxygen hot gases are extracted from the flame root such that the injected fuel aerosol particles vaporize immediately and then mix with the combustion air to form a homogeneous fuel-air-gas mixture with hot low-oxygen combustion gases. This is reflected in extremely good cold start behavior in the boiler.

Advantageously, the output can be adapted to the heat requirement in at least one stage, two stages, advantageously three stages, and more advantageously continuously. This has the advantage that the burner needs to be switched on and off less often, which results in a longer service life.

Advantageously, the output can be adjusted between approximately 25% and 100% of full load by varying the blower pressure. This is a significantly larger adjustment range compared to conventional oil burners.

Advantageously, the fuel-air-gas mixture is ignited at a distance from the inlet nozzle. The fuel-air-gas mixture is expediently ignited at an axial distance of between 20 and 90 mm, advantageously between 25 and 80 mm and more advantageously between 30 and 60 mm from the nozzle. Advantageously, the hot gases are deflected at an angle of 90 degrees by the flame-deflecting part. Inasmuch as the combustion process is largely complete before the hot gases hit the flame-deflecting part, it is no longer essential that the hot gases are deflected at an angle of 180 degrees into the space between the flame tube and heat exchanger to extend the dwell time. A flat ceramic or fireclay plate is sufficient to deflect the hot gases. The deflecting part can also be cooled since the combustion process is already largely complete when the hot gas hits the deflecting part.

Advantageously, the hot gases are partially recirculated to the flame root. This has the advantage that the flame burns blue after a maximum of 3 seconds, preferably after less than 2 seconds and more advantageously after less than one second. This has the advantage that the blue flame burner operated according to the method burns with a soot level of zero.

The method according to the invention can achieve a combustion chamber load of at least 2 MW/m³, advantageously at least 2.5 MW/m³ and more advantageously at least 3 MW/m³ when the burner is at full load. The combustion chamber loads mentioned are significantly higher than those of known condensing boilers.

Advantageously, a blower pressure of at least 4 mbar to maximum 28 mbar, advantageously more than 5 mbar and more advantageously more than 6 mbar is generated (measured in the inflow chamber and upstream of the faceplate). This has the advantage that the output of the burner can be regulated over a very wide range.

The burner output is advantageously regulated by means of the blower and oil pressure. This can be accomplished by means of control of the boiler and the coupling with the electronics for controlling the permanent magnet motor oil pump unit.

Advantageously, a speed-regulated blower is used, which allows speeds to advantageously be adjusted in the range between approximately 3,500 and 10,000 rpm. This makes it possible to vary the blower pressure and thus the output range very widely. This moreover has the advantage that a high differential pressure can be generated in the combustion chamber between the evaporation zone and the space between the flame tube and heat exchanger with a blower pressure of 5 mbar at low load and up to approximately 28 mbar at full load when entering the flame tube.

The combustion quality is advantageously detected via a sensor. Either a carbon monoxide sensor or a lambda probe can be used as a sensor. This allows the combustion process to be automated and optimally adjusted via the control unit and the controlled addition of air.

The flame is expediently monitored using an ionization electrode. This solution is cost-effective and requires no fine adjustment. This offers the advantage that the fuel supply can be interrupted immediately if no flame can be detected.

The burner is advantageously monitored with a burner safety monitor. Control units and operating parameters as are normally used for gas burners can be used for this type of burner safety monitoring. This means that the burner must light within seconds of starting, otherwise it will be switched off again after approximately 3 seconds safety time.

Recirculation slots or openings are advantageously provided in a radial configuration in the flame tube, in the region of the evaporation and mixing zone. This enables the recirculation of combustion gases from the combustion chamber into the evaporation and mixing zone. Even if recirculation openings can be provided on the flame tube side directly adjacent to the baffle plate and also at a distance of 10 to 30 mm from it, the recirculation openings are advantageously provided exclusively at a distance of between 15 and 40 mm, advantageously between 20 and 35 mm.

Advantageously, the strictest standards are met with a residual oxygen content of 3% in the combustion gases. At the time of drafting of this application, these standards are maximum 60 mg/kWh for carbon monoxide, maximum 120 mg/kWh for NOx, and maximum 10 ppm for CxHy.

The combustion process is advantageously controlled in such a way that the carbon monoxide content in the combustion gases is <60 mg/m³, advantageously <30 mg, and the NOx content is <120 mg/m³, advantageously <70 mg/m³.

Depending on the desired output, the burner is advantageously regulated to less than 60%, advantageously less than 50% and more advantageously less than 40% of its maximum output.

The permanent magnet motor oil pump unit is expediently used in a single-stage, two-stage manner.

Advantageously, the permanent magnet motor oil pump unit with electronics and PWM signal (pulse width modulation) is coupled to the PWM signal of the electronics of the blower motor.

According to an independent aspect of the invention, the ignition of the fuel-air-gas mixture takes place laterally through a lateral opening in the flame tube. This has the advantage that the flow conditions inside the flame tube are not disturbed by the electrodes.

Advantageously, a combustion chamber pressure of between 0.7 and 2.5 mbar, advantageously between 0.8 and 2 mbar and more advantageously between 0.9 and 1.5 mbar, is set in the combustion chamber outside the flame tube, which is to say, when the burner is under full load, in the space between the heat exchanger and the flame tube. In general, an overpressure of approximately 1 mbar is advantageously set in the space between the heat exchanger and the flame tube.

The subject matter of the present invention is also a condensing boiler or a condensing combi boiler with a blue flame burner, according to the general term of claim 36. The burner according to the invention is characterized in that the blower is advantageously capable of generating a high blower pressure and that the air inlet into the flame tube is configured in such a way that, at full load of the burner, a differential pressure zone with a differential pressure of at least 0.25 mbar, advantageously at least 0.30, and more advantageously at least 0.35 mbar, compared to the pressure in the combustion chamber between the flame tube and the heat exchanger, can be generated.

Advantageously, the faceplate has a plurality of guide vanes projecting at an angle in such a way that during operation of the burner, under full load, a differential pressure zone of at least 0.25 mbar, advantageously at least 0.30 mbar, and more advantageously at least 0.35 mbar, compared to the pressure in the combustion chamber between the flame tube and the heat exchanger, can be generated. Advantageously, the guide vanes are arranged at an angle of between 20 and 40 degrees, advantageously at an angle of approximately 30 degrees, relative to the radial plane of the faceplate.

The guide vanes are expediently configured as guide blades. These guide vanes must be configured in such a way that the highest possible differential pressure can be generated in the flame tube during operation of the burner.

The guide vanes advantageously have a trapezoidal shape in their initial state, wherein during the manufacture of the guide vanes, the trapezoidal diagonals are substantially twisted along their entire length. This allows the combustion air, which enters the flame tube almost exclusively via the central opening of the faceplate, to be set in rotation, thereby extending the dwell time of the hot gases in the flame tube. The guide vanes are formed on a disk with a central opening, wherein the guide vanes are connected to the disk by means of a web. The web width a of the guide vane in relation to the diameter d of the faceplate is less than approximately 10, advantageously less than 8, and more advantageously less than 6.

Advantageously, the guide vane is configured in such a way that the combustion air is directed into the flame tube at an angle and set in rotation, wherein a differential pressure is generated and part of the hot gas-air-fuel-gas mixture is partially recirculated to the faceplate, on the one hand, from the flame root and, on the other hand, through the recirculation openings. This has the advantage that the burner has excellent cold start behavior.

Advantageously, the faceplate has at least three, advantageously at least five and more advantageously at least seven guide vanes arranged in a circle and advantageously at regular intervals from one another. The guide vanes advantageously have such a shape that air passing through the guide vane creates a suction effect.

Depending on its shape, the faceplate is advantageously arranged up to 2.5 mm before or up to 2 mm after the atomizer nozzle in the direction of flow. The precise positioning of the faceplate is expediently such that a partial recirculation of the air-fuel-gas mixture towards the faceplate takes place.

The faceplate is expediently configured as a disc, in the center of which the atomizer nozzle can be arranged.

The blower pressure generated by the blower can advantageously be adjusted between approximately 4 mbar at low load and up to approximately 28 mbar at full load. This makes it possible to adjust the burner output over a very wide range.

According to an advantageous embodiment, the flame tube length at a maximum burner output of 22 kW is <150 mm, advantageously less than 140 mm and more advantageously less than 130 mm. The length of the flame tube is advantageously between 80 and 120 mm, but could also be even shorter.

With a flame tube diameter of 90 mm, the recirculation openings advantageously occupy a region of between approximately 130 mm² and 1030 mm², advantageously between 300 mm² and 800 mm², and more advantageously between 500 mm² and 700 mm².

With a flame tube diameter of 70 mm, the recirculation openings advantageously occupy a region of between approximately 100 mm² and 800 mm², advantageously between 300 mm², and 750 mm² and more advantageously between 450 mm² and 550 mm².

With a flame tube diameter of 80 mm, the recirculation openings advantageously occupy a region of between approximately 100 mm² and 900 mm², advantageously between 300 mm² and 750 mm², and more advantageously between 450 mm² and 650 mm².

According to one embodiment, a burner housing closing the boiler housing on one side is provided, on which burner housing the flame tube and the nozzle unit are arranged and the inlet for combustion air is provided. This allows easy disassembly, inspection, and, if necessary, cleaning of the nozzle unit.

The burner housing is advantageously closed with a detachable burner housing cover, in which the nozzle unit is arranged.

The burner housing advantageously defines an annular inflow chamber for the combustion air.

The nozzle unit advantageously comprises a nozzle body with a nozzle body head located outside the burner housing and a nozzle body shaft extending in the inflow chamber and accommodating the nozzle.

At least the nozzle body shaft, advantageously the entire nozzle unit, is expediently made of a material with good thermal conductivity, for example, brass or aluminum. This has the advantage that any heat remaining after the burner has been switched off can easily be dissipated.

An atomizer nozzle with an approximately 80° full cone or hollow cone is advantageously used as nozzle.

At least one strainer insert, advantageously a perforated plate with a hole diameter of between 1 and 3 mm, is advantageously provided upstream of the faceplate to calm the combustion air in the direction of flow. The use of a strainer insert has the advantage that the combustion air can flow more evenly into the flame tube.

A gas burner control unit with a safety time in accordance with the standards for gas can advantageously be used to monitor the burner. This has the advantage that commercially available products can be used with attractive purchase prices for these components.

Advantageously, the ratio of the combustion air pressure upstream of the faceplate and the differential pressure in the flame tube, as well as the pressure in the combustion chamber and the differential pressure in the recirculation opening in the flame tube are automatically adjusted according to the selected output. This is achieved by the fact that the speed of the blower can, for example, be regulated between 3,500 rpm and 10,000 rpm depending on the burner output selected by a comfort regulator and the automatic burner control.

The boiler expediently comprises a control unit and valves that can be regulated connected to the control unit for controlling the air and fuel quantity. This, in combination with the other structural features of the boiler according to the invention, allows the combustion process to be adjusted in such a way that the strictest exhaust gas standards can easily be met.

The control unit is advantageously configured in such a way that the quantity of air supplied and the amount of fuel supplied can be controlled depending on one another.

The burner output can advantageously be adjusted up to a control ratio of 1:4. This makes it possible to operate the burner continuously over a longer period of time. Due to the reduced number of switch-offs and switch-ons, the service life of the burner can be significantly increased and energy savings further improved.

The boiler advantageously comprises a pressure generator for regulating the oil pressure, wherein the oil pressure can advantageously be regulated in a range between 3 bar and 28 bar.

According to an advantageous embodiment, the ratio of flame tube length to flame tube diameter is between 1.6 and 0.8 and advantageously between 1.4 and 0.9 and more advantageously between 1.2 and 0.95.

A plate made of a ceramic material, for example, a ceramic fiber plate, or a bumper boiler end can be used as a flame-deflecting part. It is also conceivable to cool the deflecting part with, for example, water.

The blower is advantageously configured to generate, in the space between the flame tube and the heat exchanger, a pressure of more than 0.2 mbar, advantageously more than 0.3 mbar and more advantageously more than 0.4 mbar relative to the surroundings, as measured at the height of the flame tube where the greatest differential pressure prevails relative to the inside of the flame tube, which is to say, between approximately 10 and 30 mm after the faceplate. Such a blower pressure is important for the achievement of a high combustion chamber load.

Due to the advantageous properties of the burner according to the invention, a direct current high pressure blower, as is already available as standard for gas burners, can be used. Such a high pressure blower advantageously enables speeds of, for example, 3,500 rpm to 10,000 rpm. This allows high boiler chamber resistances of up to 2 mbar, or even more, to be overcome in a condensing split coil boiler. The distance between the windings in a split coil heat exchanger is advantageously in the range of approximately 0.8 to 1.3 mm.

The burner can advantageously also be used for reduced-sulfur fuels with a sulfur content S<300 mg/kg, low-sulfur fuels with a sulfur content S<80 mg/kg, more advantageously S<10 mg/kg and in particular for liquid synthetic fuels, in particular renewable biomass to liquid (BTL) fuels and e-fuels.

One or more sensors, in particular ionization electrodes, light-sensitive sensors, carbon monoxide sensors, pressure sensors and/or lambda probes, are advantageously provided for monitoring the burner.

The flame tube advantageously has a straight cylinder without constriction at the end. This means that the flame tube can have a simple configuration because no constriction is required at the end of the flame tube to stabilize the flame.

The ignition electrodes are advantageously guided through an opening in the flame tube casing at a distance downstream of the air faceplate of between 40 and 55 mm, advantageously approximately 50 mm.

The subject matter of the present invention is also a condensing combi boiler with a boiler according to any one of claims 36 through 75, which is characterized in that the water content of the heat exchanger at a maximum output of 22 kW is less than seven liters, advantageously between 2.8 and 6 liters and more advantageously between approximately 4.5 and 5.5 liters. Such a condensing combi boiler can be used very well as an on-demand water heater for heating water for industrial use because the possible high combustion chamber load and the low volume of the coolant present in the heat exchanger mean that hot water for industrial use of up to 60° C. can be produced very quickly, which is to say, in less than a minute.

The subject matter of the present invention is also a boiler according to the generic term of claim 76, which is characterized in that an opening for the feedthrough of the ignition electrodes is provided in the flame tube casing.

Another subject matter of the present invention is a boiler according to the generic term of claim 78, which is characterized in that a burner housing defining an inflow chamber for combustion air is provided, in which a strainer insert is provided for air calming.

### BRIEF DESCRIPTION OF THE DRAWINGS

The invention is explained in more detail below with reference to the accompanying figures. Wherein:

FIG. 1: Shows a perspective view of a first embodiment of a boiler according to the invention comprising a boiler housing, a heat exchanger arranged in the boiler housing, as well as a burner unit with a blower arranged on one end face of the boiler housing, wherein a part of the boiler is cut away along two lines for better illustration;

FIG. 2: Shows the cross-sections of the boiler of FIG. 1;

FIG. 3: Shows a top view of the burner unit of the boiler of FIG. 1;

FIG. 4: Shows a bottom view of the burner unit of the boiler of FIG. 1, with the housing cover omitted;

FIG. 5: Shows a perspective view of the burner unit of FIG. 1, where parts of the burner unit have been cut away for better illustration;

FIG. 6: Shows the burner unit with flame tube and blower in cross-section as shown in FIG. 5;

FIG. 7: Shows a perspective view of the nozzle body of the burner unit;

FIG. 8a: Shows the nozzle body of FIG. 7 in longitudinal cross-section along line I;

FIG. 8b: Shows the nozzle body of FIG. 7 with atomizer nozzle in longitudinal cross-section along line II;

FIG. 9: Shows a perspective view of a faceplate of the burner before deformation;

FIG. 10: Shows a perspective view of the faceplate of FIG. 9 in the finished state;

FIG. 11: Shows the burner unit of FIG. 1 with a first embodiment example of an air calming device;

FIG. 12: Shows the burner unit of FIG. 1 with a second embodiment example of an air calming device;

FIG. 13 Shows the burner unit of FIG. 1 with a third embodiment example of an air calming device;

FIG. 14: Shows a second embodiment example of a burner unit with ignition electrodes and sensor arranged in the flame tube;

FIG. 15: Shows the schematics of a heating system with the boiler according to the invention for the production of water for industrial use and hot water for a heating system;

FIG. 16: Shows the schematics of a heating system with the boiler according to the invention for the production of water for industrial use in an on-demand water heater and hot water for a heating system;

FIG. 17: Shows one half of the boiler according to the invention in cross-section and thereunder a diagram in which the differential pressure in the flame tube is shown as a function of the distance from the baffle plate;

FIG. 18: Shows one half of a previously known boiler with a blue flame burner in cross-section and thereunder a diagram in which the differential pressure in the flame tube is shown as a function of the distance from the baffle plate;

FIG. 19 Shows a second embodiment of a faceplate with centering nubs;

FIG. 20 Shows the flame emerging from the flame tube in a burner according to the invention;

FIG. 21 By comparison, shows the flame in a conventional blue flame burner.

### DETAILED DESCRIPTION OF THE INVENTION

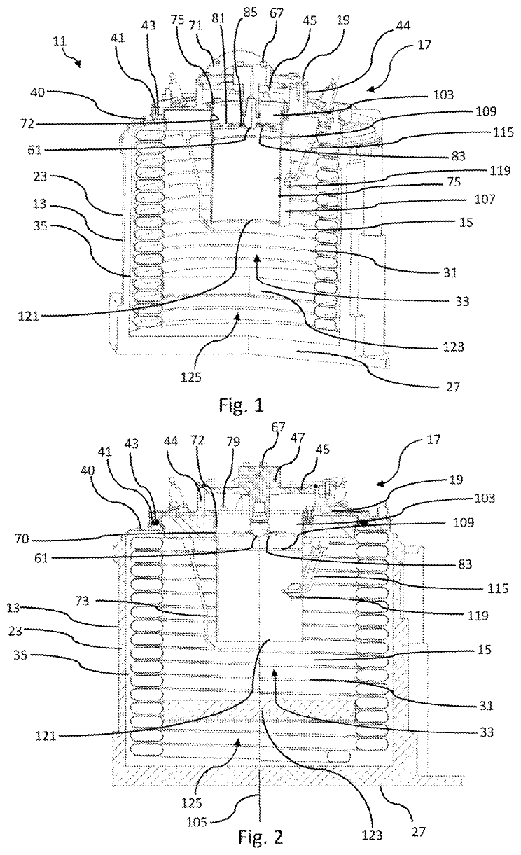

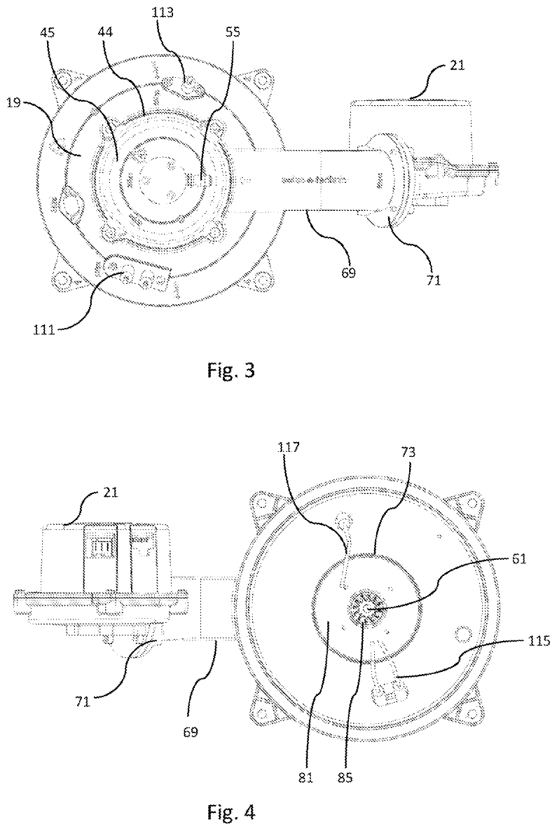

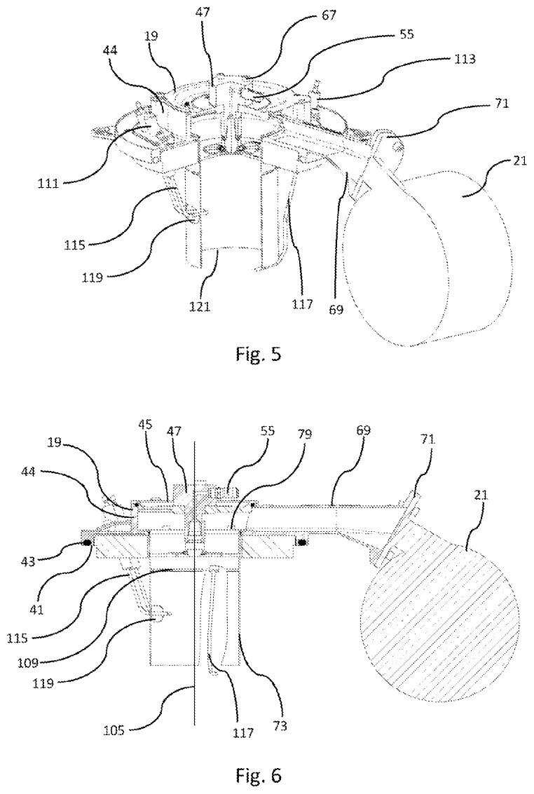

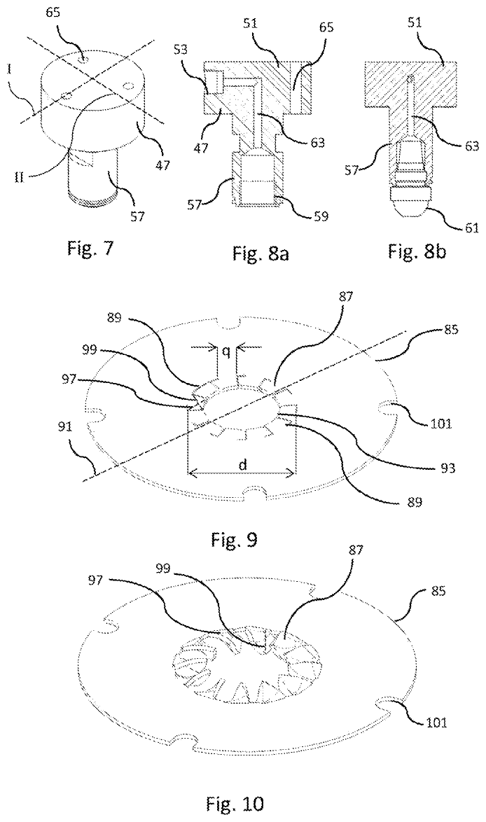

FIG. 1 through FIG. 8 show a first embodiment example of a boiler 11 according to the invention, the essential components of which are a cylindrical boiler housing 13, a jacket-shaped heat exchanger 15 arranged in the boiler housing 13 and a burner unit 17 with a burner housing 19 and a blower 21 arranged thereon.

The boiler housing 13 comprises a housing casing 23, which is closed off at one end by a housing base 27 (not shown as a separate component in the figures) and at the other end by the burner housing 19. The jacket-shaped heat exchanger 15 advantageously consists of a helically wound, corrosion-resistant heat exchanger tube, wherein pass-through openings 31 are present for the combustion gases between adjacent tubes. The heat exchanger 15 is inserted into the boiler housing 13 and divides its interior into a combustion chamber 33 and a exhaust gas chamber 35.

The burner housing 19 is fastened by an edge to a flange 40 on the front of the boiler housing 13. An annular groove 41 is provided in the edge, into which a seal 43 is inserted. The burner housing 19 has an offset cylindrical connection piece 44, which can be closed off by a burner housing cover 45. A nozzle unit 47 is detachably fastened to the burner housing cover 45.

The nozzle unit 47 consists of a nozzle body with a head 51 with a lateral threaded hole 53 for receiving a quick coupling 55 for connecting a fuel line (not shown) and a nozzle body shaft 57 with a frontal threaded hole 59 for receiving a nozzle 61 (FIG. 8b), advantageously one with a hollow or full cone characteristic. The threaded holes 53, 59 are connected to each other via a connecting channel 63. Three through holes 65 are provided in the head 51 for receiving three fastening screws 67, with the aid of which the nozzle unit 47 is detachably fastened to the burner housing cover 45.

A pipe socket 69 for supplying combustion air to the burner housing 19 is also arranged or directly molded onto the burner housing 19. The blower 21 is connected to this pipe socket 49 at a flange 71.

A flame tube unit 70 consisting of burner tube 72 and flame tube 73 is arranged on burner housing 19. The burner tube 72 has a flared edge 75 at the base, which flared edge rests against an inwardly projecting ring shoulder 77 of the burner housing 19 and which is firmly screwed to it (screws 79). A baffle plate 81 is placed upon the burner tube 72, which apart from a central opening 83, closes off the burner tube 72. A faceplate 85 is applied into or onto this opening 83. A plurality of guide vanes 87 protruding at an angle is formed on the faceplate 85, the purpose of which is to cause the combustion air flowing into the flame tube 73 to rotate and to generate a sufficiently large differential pressure downstream of the baffle plate so that some of the hot gases from the flame and additional hot combustion gases from the remaining combustion chamber outside the flame tube 73 are recirculated to the flame root. The flame tube 73, which has a slightly smaller diameter than the burner tube 72, is placed on the burner tube 72 or the baffle plate 81 that closes it. It is conceivable to manufacture the combustion tube and flame tube in one piece and to weld the baffle plate to the inner wall of the flame tube.

FIG. 9 and FIG. 10 respectively show the faceplate 85 as an intermediate product (FIG. 9) and then as a finished part (FIG. 10). In FIG. 9, the faceplate 85 is shown as a still flat part after it has been cut out of a larger piece of sheet steel using a laser cutter. The guide vane 87, which is approximately trapezoidal in its initial state, is only connected to the rest of the disk via a web 89. To manufacture the faceplate 85, the approximately trapezoidal vanes are, on the one hand, twisted about an axis 91 running radially through the web 89, in an upward direction in FIG. 10, and, on the other hand, the vanes 87 are further shaped by twisting the radially inner trapezoidal edges 93 relative to the radially outer edges 95. This results in guide blades in which the trapezoidal diagonals 97, 99 are curved (curved downwards in FIG. 10). It is important that the guide vane 87 has such a shape that a maximum differential pressure can be generated at a distance from the baffle plate.

Several recesses 101 are provided on the periphery of the faceplate 85, which recesses serve to accommodate fastening screws with which the faceplate 85 can be screwed to the baffle plate 57. It is of course possible to make the baffle plate and faceplate in one piece.

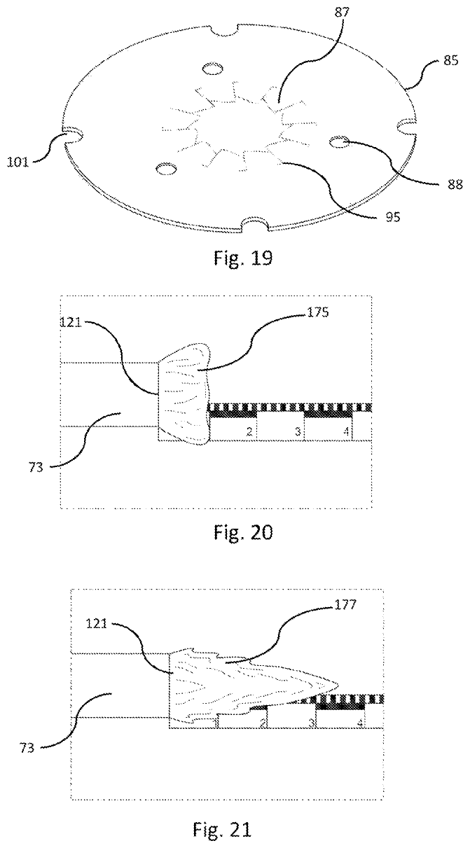

FIG. 19 shows a further embodiment of a faceplate 85. In contrast to the faceplate shown in FIG. 9, this has sawtooth-like guide vanes 87. These guide vanes have the advantage that the faceplate with the twisted vanes does not come into conflict with the nozzle 61. Another difference is given by three centering nubs 88 which allow the faceplate 85 to be centered in the central opening 83 of the baffle plate 81.

The burner housing 19 together with the burner housing cover 45 defines the burner tube 72, and the baffle plate 81 together with faceplate 85 defines an inflow chamber 103.

The cylindrical flame tube 73 extends in the axial direction 105 almost to the center of the combustion chamber 33. At a short distance from the baffle plate 81, advantageously at a distance of between 5 and 18 mm, recirculation slots 109, advantageously in the form of recirculation slots, are provided in the flame tube 73 in the circumferential direction, which openings serve to recirculate low-oxygen combustion gases from the surrounding combustion chamber 33 into the flame tube 73. The recirculation slots 109 advantageously have a width of between 1.1 and 3.5 mm and more advantageously a width of between 1.5 and 3.0 mm, ideally between approximately 2.0 and approximately 2.5 mm, with an output of up to approximately 22 kWh.

Feedthroughs 111 and 113 are provided in the burner housing 19 for ignition electrodes 115 and a monitoring sensor 117, for example, an ionization electrode, for flame monitoring. The ignition electrodes 117 are arranged in the combustion chamber 33 between heat exchanger 15 and flame tube 73 and extend with their ends through an opening 119 in the flame tube casing into the flame tube 73. Similarly, the monitoring sensor 115 extends in the space between heat exchanger 15 and flame tube 73 all the way to the flame tube opening 121, so that the presence of a flame (ionization process) can be detected during operation. The described arrangement of the electrodes 115 and the sensor 117 has the advantage that they do not or only insignificantly disturb the flow conditions inside the flame tube 73.

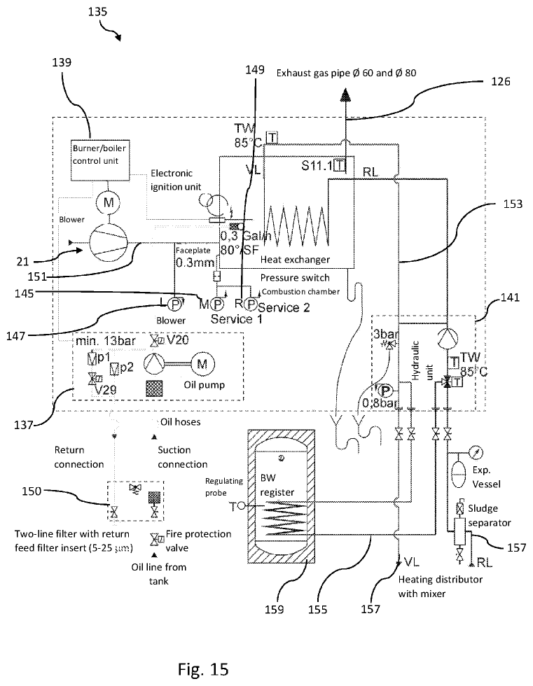

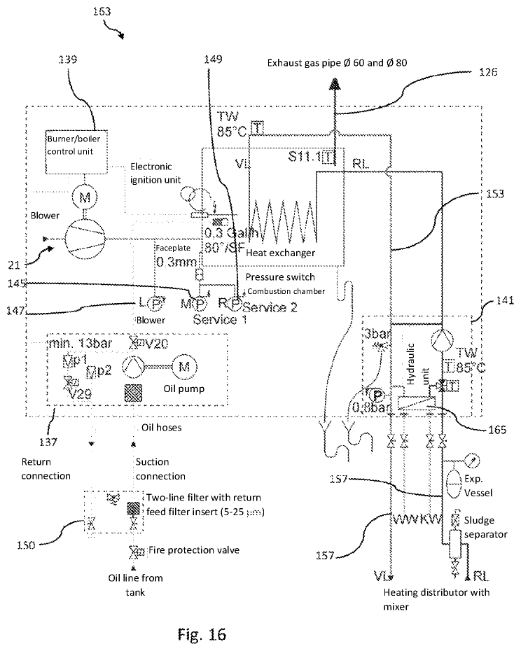

A flame-deflecting part 123 is provided at a distance from the flame tube opening 121, which flame detector limits the combustion chamber 33 in the axial direction 105. The flame-deflecting part 123 serves to deflect the flame, which need not be visible, that emerges from the flame tube opening 121 at an angle of essentially 90 degrees in the direction of the jacket-shaped heat exchanger surface. A small portion of the combustion gases is directed into the space between flame tube 73 and heat exchanger 15 and is then recirculated through the recirculation openings 109 into a vaporization zone located in the region of the recirculation openings 109, whereas the larger portion of the combustion gases passes through the slit-like pass-through openings 31 between the heat exchanger tubes into the exhaust gas chamber 35 and is thereby cooled. The combustion gases are then further cooled on their way into an outflow chamber 125 located behind the deflecting part 123 and from there enter an exhaust gas outlet not shown in the figures, to which an exhaust gas pipe 126 is connected (FIG. 15, FIG. 16).

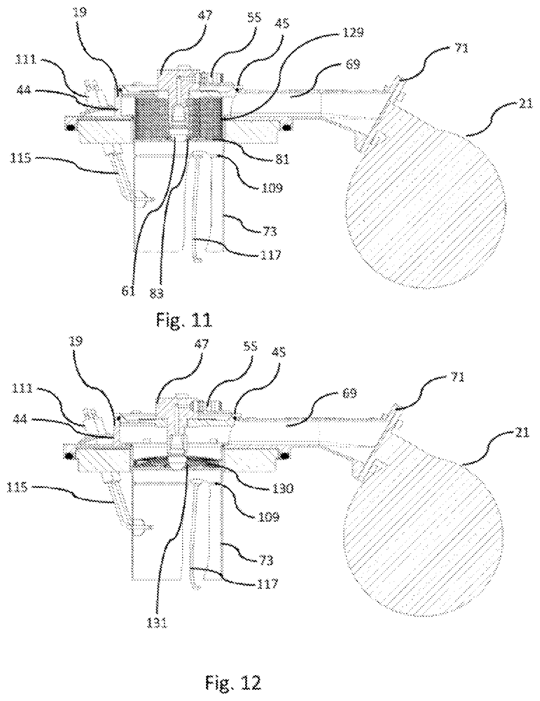

FIG. 11 to FIG. 13 show various embodiments of a burner with an air calming device. According to a first embodiment (FIG. 11), this consists of a cylindrical strainer insert 129, made from a perforated plate, which is inserted into the inflow chamber 103. The strainer insert 129 ensures that the combustion air flows in an evenly distributed manner over its entire circumference into the inflow chamber 103.

According to another embodiment, the air calming device consists of an substantially flat or slightly curved strainer insert 130 made of two circular and advantageously curved perforated plates arranged one above the other, which plates rest against the baffle plate 81 on the nozzle side. Recesses 131 for the nozzles 61 are provided in the center of the strainer insert. The strainer insert 130 serves to calm the air flowing out of the inflow chamber 103.

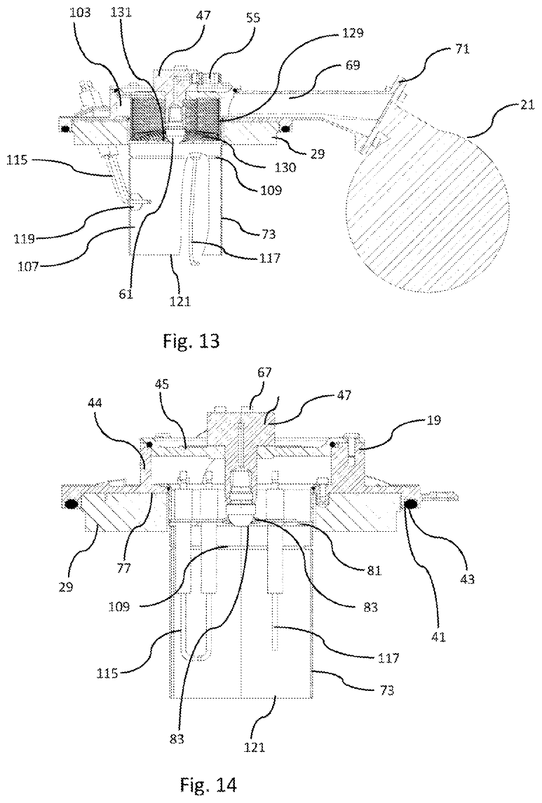

The third embodiment of the air calming device consists of a combination of the first two embodiments 129 and 130 (FIG. 13).

The embodiment of the burner in FIG. 14 differs from the other described embodiments in that the ionization electrode 117 and the ignition electrodes 115 are arranged inside the flame tube 73. The disadvantage of this embodiment is that the flow conditions in the inflow chamber 103 as well as in the flame tube 73 are more disturbed than in the embodiments described above.

FIG. 15 shows the schematics of a heating system 135 with the boiler 11 according to the invention with blower 21, a control unit 137, an oil feed unit 139, and a hydraulic unit 141. The control unit 137 is connected to the blower 21, the oil feed unit 139, an electronic ignition unit 143, and several pressure detectors 145, 147, 149. The pressure detector 145 is used to measure the blower pressure in the air supply line 151. The other two pressure detectors 147, 149 measure or monitor the pressure in the combustion chamber 33. Different pressure threshold values, for example 1.2 mbar overpressure and 2.0 mbar overpressure, can be adjusted on the pressure detectors 147, 149, and the control unit 137 performs certain actions if the pressure exceeds or falls below these values. If an overpressure of 2 mbar is exceeded in the combustion chamber, this is an indication of contamination of the heat exchanger or a resistance in the exhaust gas pipe 126. An oil filter unit 150 with return feed is provided upstream of the oil feed unit 139.

The hydraulic unit 141 controls the generation of domestic hot water in a storage tank 159 in a known manner via corresponding pipe circuits 153.

FIG. 16 schematically shows a heating system with condensing combi boiler 163, in which an on-demand water heater 165 is provided instead of a storage tank, which on-demand water heater is used to generate hot water for industrial use. The boiler according to the invention is particularly suitable in a condensing combi boiler, inasmuch as the burner already burns with a blue flame within fractions of a second, does not require fuel preheating and the heat exchanger has a very small content of water. This makes it possible to obtain hot water of at least 50° C. within 60 seconds of starting the burner.

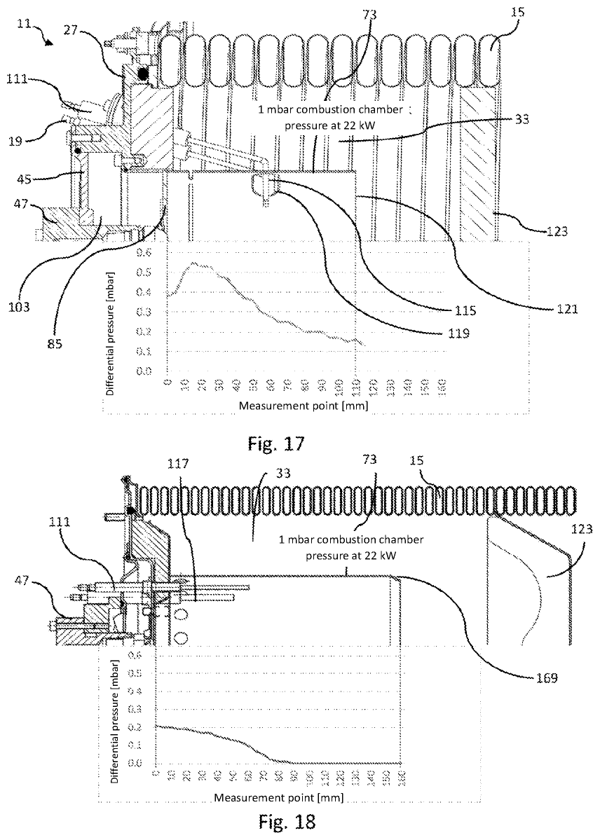

FIG. 17 shows the pressure conditions in the boiler according to the invention in more detail. The pressure was measured during operation of the burner at full load at various points within the flame tube 73 with the aid of a so-called double inclined tube manometer. As can be seen from the graph, the differential pressure at the baffle plate is already approximately 0.38 mbar. This differential pressure is a negative pressure that is measured relative to the (overall) combustion chamber pressure. The combustion chamber pressure is measured at a point outside the flame tube 73 in the rest of the combustion chamber, for example, in the intermediate space 118 between the heat exchanger 15 and the flame tube 73. In the present case, the combustion chamber pressure (overpressure relative to the ambient pressure) for a burner with a maximum output of 22 kW at full load with a clean heat exchanger is approximately 1 mbar, but can also be 0.3 mbar lower or higher.

The differential pressure increases with increasing distance from the baffle plate 85, initially to more than 0.5 mbar, and then steadily decreases all the way to the end of the flame tube. A differential pressure maximum is noticeable at a distance of between 10 and 30 mm from the baffle plate (in the range of one tenth to one third of the flame tube length).

In contrast to the boiler according to the invention, the pressure conditions in a previously known boiler differ significantly, which is to say, that the differential pressure (negative pressure) prevailing at the baffle plate is only a maximum of 0.2 mbar, which drops to zero within the flame tube 73, which is to say, approximately in the middle of the flame tube.

The completely different pressure conditions in the boiler according to the invention make it possible to build the flame tube 73 significantly shorter than in conventional burners, inasmuch as the pressure conditions result in increased recirculation of the hot gases from the flame and the low-oxygen combustion gases from the combustion chamber. Due to the rapid rotation of the air-fuel mixture in the flame tube, the combustion of the fuel is largely completed by the time it reaches the flame-deflecting part, so that the combustion gases no longer need to be diverted into the intermediate chamber 118. A further advantage of these pressure ratios is the stability of the flame within the flame tube, which is short compared to other burners. The surprisingly high stability of the flame at different blower pressures allows the continuous regulation of the burner output over an extraordinarily wide output range. In the known burner shown in FIG. 18, the flame tube still has a constriction 169 at the flame tube opening so that the flame is well-maintained at the flame tube 73 and burns stably.

FIG. 20 and FIG. 21 show the completely different flame shapes produced by a burner according to the invention and a conventional blue flame burner according to the prior art. Whereas the flame 175 spreads out like a fan after emerging from the flame tube opening 121, the flame 177 of the conventional blue flame burner is wedge-shaped and approximately three times as long. The constriction at the flame tube opening (not shown in FIG. 21, however shown in FIG. 18) is important for a stable flame. In contrast, the flame tube 73 of the burner according to the invention is a straight cylinder without constriction.

The boiler according to the invention has the advantage that it is made up of just a few assemblies, namely a boiler housing 13, a heat exchanger 15, a burner housing 19, a flame tube unit 70 with integrated baffle plate 81 and faceplate 85, a burner housing cover 45 with integrated nozzle unit 47 ignition electrodes 115 and monitoring sensor 117, and a blower 21. Another significant advantage over conventional boilers is that no mechanical adjustments need to be made. To set the optimum operating conditions, only the oil throughput needs to be set by adjusting the oil pressure at the maximum output and minimum output of the burner.

The combustion process in the boiler according to the invention works as follows: inasmuch as the air is blown in through the air openings as if by a fan and set in rapid rotation, a rotating differential pressure zone is created downstream of the baffle plate 57. This differential pressure draws in hot gases from the flame root and combustion gases from the combustion chamber via the recirculation slots. These hot gases mix in the manner of a fan with the rotating air supply and form a fan-like, air-hot gas casing. Vortexes are created between the core flow and the casing, in which vortexes the air, fuel, and hot gas media are mixed.

The flame starts in its root region approximately in the first third of the flame tube 73. The flame root is ring-shaped in the rotating air-hot gas flow with vaporized fuel and starts approximately 30 mm downstream after the faceplate. Due to the high rotation of the flame in the flame tube 73, the path for the oxidation of the fuel with the atmospheric oxygen can be drastically shortened axially and radially, so that the flame rotating out of the flame tube is deflected at an angle of 90° after hitting the deflecting part and is already oxidized to such an extent that the required emission values are reached before the hot combustion gases are passed through the slot-like pass-through openings in the heat exchanger.

Examples for dimensioning of the flame tubes of burners with different outputs:

| Maximum Burner output [kW] | 22 | 22 | 16 |
|---|---|---|---|
| Flame tube diameter [mm] | 90 | 80 | 70 |
| Flame tube length [mm] | 110 | 110 | 80 |

1-79. (canceled)

80. A condensing or condensing combi boiler using a blue flame burner, comprising:
a boiler housing with an inlet for combustion air and an outlet for combustion gases;
a cylindrical heat exchanger arranged in the boiler housing, with a slot-like pass-through openings for the combustion gases;
a flame tube arranged in the cylindrical heat exchanger so that a jacket-shaped intermediate space is defined between the flame tube and the cylindrical heat exchanger;
ignition electrodes extending into the flame tube for the ignition of the fuel-air-gas mixture;
a baffle plate with a faceplate arranged in the flame tube, through which face plate the combustion air is fed into the flame tube;
a nozzle unit with a nozzle for atomization of the fuel;
a flame-deflecting part arranged at an axial distance from the flame tube, wherein the jacket-shaped intermediate space in the flame tube and the space between the flame tube and deflecting part define a combustion chamber; and
a blower connected to the boiler housing for generating a blower pressure, the blower configured to generate a blower pressure that when the burner is at full load, a differential pressure zone is generated with a differential pressure of at least 0.25 mbar compared to a pressure in the combustion chamber between the flame tube and the heat exchanger in a region of the slot-like pass-through openings.

81. The boiler according to claim 80, wherein the faceplate has a plurality of guide vanes projecting at an angle so that during operation of the burner, under full load, a differential pressure zone of at least 0.25 mbar, compared to a pressure in the combustion chamber between the flame tube and the heat exchanger, can be generated.

82. The boiler according to claim 80, wherein the faceplate is a disc with a central opening, wherein the guide vanes are arranged around the central opening, each of the guide vanes connected to the disc by a web wherein a width of the web of the guide vane in relation to a diameter of the faceplate is less than approximately 10.

83. The boiler according to claim 80, wherein the flame-deflecting part comprises a plate of a ceramic material.

84. The boiler according to claim 80, wherein the blower is adapted to provide an adjustable blower pressure in front of the baffle plate of between approximately 4 mbar at low load and up to approximately 28 mbar at full load.

85. The boiler according to claim 80, wherein in a flame tube diameter of 90 mm, the recirculation openings occupy a region of between approximately 130 mm2 and 1030 mm2.

86. The boiler according to any claim 80, wherein in a flame tube diameter of 80 mm, the recirculation openings occupy a region of between approximately 100 mm2 and 900 mm

87. The boiler according to claim 80, wherein in a flame tube diameter of 70 mm, the recirculation openings occupy a region of between approximately 100 mm2 and 800 mm2.

88. The boiler according to claim 80, wherein a burner housing closing the boiler housing on one side is provided, on which boiler housing the flame tube and the nozzle unit are arranged and the inlet for combustion air is provided.

89. The boiler according to claim 88, wherein at the burner housing is closed with a detachable burner housing cover, in which the nozzle unit is arranged wherein the burner housing defines an inflow chamber for the combustion air.

90. The boiler according to claim 89, wherein the nozzle unit comprises a nozzle body with a nozzle body head located outside the burner housing and a nozzle body shaft extending in the inflow chamber and accommodating the nozzle.

91. The boiler according to claim 80, wherein at least the nozzle body shaft is made of a material with good thermal conductivity, for example, brass or aluminum.

92. The boiler according to claim 80, wherein at least one strainer insert, preferably a perforated plate having a hole diameter between 1 and 3 mm, is provided upstream of the faceplate to calm the combustion air in the direction of flow.

93. The boiler according to claim 80, wherein it comprises a gas burner control unit with a safety time in accordance with the standards for gas to monitor the burner, wherein the gas burner control unit is adapted such that the ratio of the blower pressure before the faceplate and the differential pressure in the flame tube automatically adjusts according to the selected output.

94. The boiler according to claim 80, wherein the burner output can be adjusted up to a control ratio of 1:4 by regulating the blower pressure.

95. The boiler according to claim 80, wherein the boiler comprises a pressure generator for regulating the oil pressure, wherein the oil pressure can be regulated in a range between 3 bar and 28 bar.

96. The boiler according to claim 80, wherein the ratio of flame tube length to flame tube diameter is between 1.5 and 0.8.

97. The boiler according to claim 80, wherein the blower is configured to generate in the space between the flame tube and the heat exchanger a pressure of more than 0.2 mbar, preferably more than 0.3 mbar and more preferably more than 0.4 mbar.

98. The boiler according to claim 80, wherein the electrodes for the ignition of the fuel-air-gas mixture are guided laterally through an opening in the flame tube.

99. The boiler according to claim 80, wherein the ignition electrodes are guided through an opening in the flame tube casing at a distance downstream of the air faceplate between 40 and 55 mm.

100. The boiler according to claim 80, wherein the boiler comprises a condensing combi boiler and wherein a water content of the heat exchanger at a maximum output of 22 kW is less than seven liters.

101. A condensing or condensing combi boiler with a blue flame burner, comprising:
a boiler housing with an inlet for combustion air and an outlet for the combustion gases;
a cylindrical heat exchanger arranged in the boiler housing with a slot-like pass-through openings for combustion gases;
a flame tube arranged in the cylindrical heat exchanger so that a jacket-shaped intermediate space is defined between the flame tube and the heat exchanger, a casing of the flame tube defining an opening configured for feedthrough of ignition electrodes;
a baffle plate with faceplate arranged in the flame tube, through which face plate combustion air is fed into the flame tube;
a nozzle unit with a nozzle for atomization fuel;
a flame-deflecting part arranged at an axial distance from the flame tube, wherein the intermediate space in the flame tube and a space between the flame tube and the flame-deflecting part defines a combustion chamber; and
a blower connected to the boiler housing for generating a blower pressure.

102. A condensing or condensing combi boiler with a blue flame burner, comprising:
a boiler housing with an inlet for combustion air and an outlet for the combustion gases;
a cylindrical heat exchanger arranged in the boiler housing, with a slot-like pass-through openings for combustion gases;
a nozzle unit having a nozzle for atomization fuel;
a flame-deflecting part arranged at an axial distance from a flame tube, wherein a first space in the flame tube and a second space between the flame tube and deflecting part define a combustion chamber;
a blower connected to the boiler housing for generating a blower pressure;
a burner housing defining an inflow chamber; and
a strainer insert in the burner housing for air calming.
